(19) United States
(12) Patent Application Publication
(10) Pub. No.: US 2012/0015120 A1
(43) Pub. Date: Jan. 19, 2012

(54) MAGNETICALLY ATTACHABLE DECORATIVE ITEMS

(75) Inventors: Viola E. Haegele, Town & Country, MO (US); Samantha A. Nelson, Valley Park, MO (US)

(73) Assignee: LIFE SIMPLER LLC, Town & Country, MO (US)

(21) Appl. No.: 13/178,173

(22) Filed: Jul. 7, 2011

Related U.S. Application Data
(60) Provisional application No. 61/364,080, filed on Jul. 14, 2010.

(51) Int. Cl. B32B 3/06; B32B 1/06; H01F 7/02

(52) U.S. Cl. 428/34.1; 24/303; 428/99; 428/68; 428/76

(57) ABSTRACT

The present disclosure provides ornamental items used to compliment, adorn, decorate or accessorize personal items such clothing, apparel, shoes, purses, backpacks, scarves, belts, headwear, etc., wherein the ornamental items are magnetically attachable to such personal items.

### CROSS-REFERENCE TO RELATED APPLICATIONS

This application claims the benefit of U.S. Provisional Application No. 61/364,080, filed on Jul. 14, 2010. The disclosure of the above application is incorporated herein by reference in its entirety.

### FIELD

The present teachings relate to ornamental items used to compliment, adorn, decorate or accessorize personal items such as clothing, apparel, shoes, purses, backpacks, scarves, belts, headwear, etc., and more particularly to ornamental items that are magnetically attachable to such personal items.

### BACKGROUND

The statements in this section merely provide background information related to the present disclosure and may not constitute prior art.

In today's society personal fashion choices are very broad throughout the various and diverse demographics and sectors of society. Typically, the way a person dresses and accessorizes his/her ‘outfit’, i.e., his/her ensemble or the aggregate compilation of personal items such as clothing, apparel, footwear, headwear, belt and hand carried items, e.g., a purse, handbag, wallet, backpack, etc., is very individualized and a form of personal expression.

To individualize one's ‘look’, i.e., the personalized aggregate appearance of one's outfit or ensemble, the person will often compliment, adorn, decorate or accessorize one or more personal items of their outfit with ornamental items having aesthetic or expressive value. Typically, such ornamental items are temporarily attached to the respective personal item(s) using pins, e.g., straight pins, safety pins, or clasping pins affixed to the respective ornamental item, or permanently attached to the respective personal item(s) via sewing or an adhesive, e.g., iron on adhesive.

Such ornamental items that are pinned to a personal item can damage the respective item(s) by leaving holes, snags or runs in the respective item(s), while such ornamental items that are permanently attached to the respective personal item(s) do not provide the versatility to move or change the respective ornamental item.

### SUMMARY

The present disclosure provides ornamental items used to compliment, adorn, decorate or accessorize personal items such as clothing, apparel, shoes, purses, backpacks, scarves, belts, headwear, etc., wherein the ornamental items are magnetically attachable to such personal items.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an illustration of a magnetically attachable ornamental item, in accordance with various embodiments of the present disclosure.

FIG. 1A is an exploded cross section side view block diagram, along line A-A, of the magnetically attachable ornamental item shown in FIG. 1, in accordance with various embodiments of the present disclosure.

FIG. 1B is a cross sectional side view block diagram, along line A-A, of the magnetically attachable ornamental item shown in FIG. 1, in accordance with various embodiments of the present disclosure.

FIG. 1C illustrates the magnetically attachable ornamental item shown in FIG. 1, magnetically attached to various personal items, in accordance with various embodiments of the present disclosure.

FIG. 1D illustrated various accessorizing articles of the magnetically attachable ornamental item, shown in FIG. 1, in accordance with various embodiments of the present disclosure.

FIG. 1E exemplarily illustrated a first and second connector of a magnetic fastener of the magnetically attachable ornamental item, shown in FIG. 1, in accordance with various embodiments of the present disclosure.

FIG. 2 illustrates a back side of various magnetically attachable ornamental items, such as that shown in FIG. 1, having the first connector of the magnetically attachable ornamental item permanently affixed to the back side, in accordance with various embodiments of the present disclosure.

FIG. 3 illustrates a back side of the magnetically attachable ornamental item, shown in FIG. 1, having the first connector disposed within an enclosure affixed to the back side, in accordance with various embodiments of the present disclosure.

FIG. 4 illustrates the magnetically attachable ornamental item, shown in FIG. 1, having the first connector integrally formed with the accessorizing article, in accordance with various embodiments of the present disclosure.

FIG. 5 is an illustration of the magnetically attachable ornamental item, shown in FIG. 1, including an accessorizing article retrofit kit, in accordance with various embodiments of the present disclosure.

FIG. 5A is an illustration of a first connector enclosure assembly of the accessorizing article retrofit kit, shown in FIG. 5, in accordance with various embodiments of the present disclosure.

FIG. 5B is an illustration of the first connector enclosure assembly, shown in FIG. 5A, attached to the back of an accessorizing article, in accordance with various embodiments of the present disclosure.

FIG. 6 is an illustration of the magnetically attachable ornamental item, shown in FIG. 1, wherein the personal item is manufactured having the second connector integrally formed therewith, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

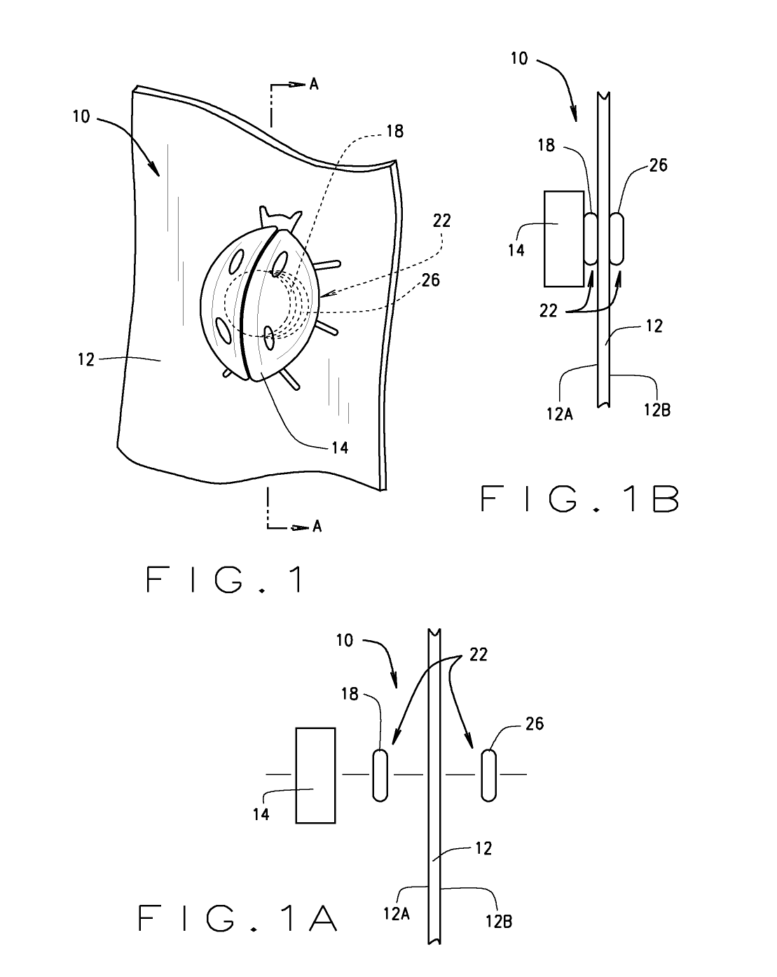

Referring to FIGS. 1, 1A, 1B, 1C, 1D and 1E, the present disclosure provides a magnetically attachable ornamental (MAO) item 10 used to compliment, adorn, decorate or accessorize a personal item 12 such as pants, skirts, dresses, shirts, blouses, tops, socks, shoes, coats, jackets, other clothing and apparel, purses, backpacks, scarves, belts, headbands, hats, headwear, etc. etc. In various embodiments, the MAO item 10 includes an accessorizing article 14, a first connector 18 of a magnetic fastener assembly 22, and a second connector 26 of the magnetic fastener assembly 22. The first connector 18 is affixed to, or integrally formed with, the accessorizing article 14 and is magnetically connectable to the second connector 26 via a magnetic field strong enough to penetrate a portion of the personal item 14 such that the accessorizing article 14 can be fastened to the personal item 12 via the magnetic attraction between the first and second connectors 18 and 26.

More particularly, to fasten the accessorizing article 14 to personal item 12, the first connector 18, having the accessorizing article 14 affixed thereto or integrally formed therewith, can be positioned at a desired location on a first side 12A of the personal item 12. Subsequently, the second connector 26 can be placed on an opposing second side 12B of the personal item 12 directly opposite the accessorizing article/first connector 14/18. Consequently, due to the strong magnetic attraction between the first and second connectors 18 and 26, the first and second connectors 18 and 26 will be drawn together, thereby firmly clasping and retaining the personal item 12 between the first and second connectors 18 and 26. Accordingly, the accessorizing article 14 can be easily attached to the personal item 12, at any desired location, without any portion of the MAO item 10 physically penetrating, e.g., poking a hole in, the personal item 12 or causing damage to the personal item 12.

In various implementations, the first connector 18 can comprise a permanent magnet, e.g., a rare-earth magnet, and the second connector 26 can comprise a button including a ferromagnetic material that is magnetically attracted to the first connector 18, e.g., iron, nickel or cobalt. Alternatively, in various implementations, the second connector 26 can comprise a permanent magnet, e.g., a rare-earth magnet, and the first connector 18 can comprise a button including a ferromagnetic material that is magnetically attracted to the second connector 26, e.g., iron, nickel, cobalt. Still further, in various implementations, both the first and second connectors 18 and 26 can comprise a permanent magnet, e.g., a rare-earth magnet, such that the strength of the magnetic field between the first and second connectors 18 and 26 when brought in close proximity to each other is increased and will penetrate a personal item 12 having a thicker cross-section or a denser material structure. However, as exemplarily illustrated in FIG. 1E, for simplicity and clarity, the second connector 26 will be described herein as a permanent magnet, e.g., a rare-earth magnet, and the first connector 18 will be described herein as being a button including a ferromagnetic material that is magnetically attracted to the second connector 26, e.g., iron, nickel or cobalt.

The accessorizing article 14 can be any decorative article, item or object suitable to compliment, adorn, decorate or accessorize the personal item 12. For example, the accessorizing article can include such items a brooches, faux floral objects, ornamental trinkets, or any cloth, paper, plastic, wood or metal artistic, aesthetic or ornamental object displaying such things as initials, horoscope symbols, religious symbols, holiday decorations, desired emblems, words, etc.

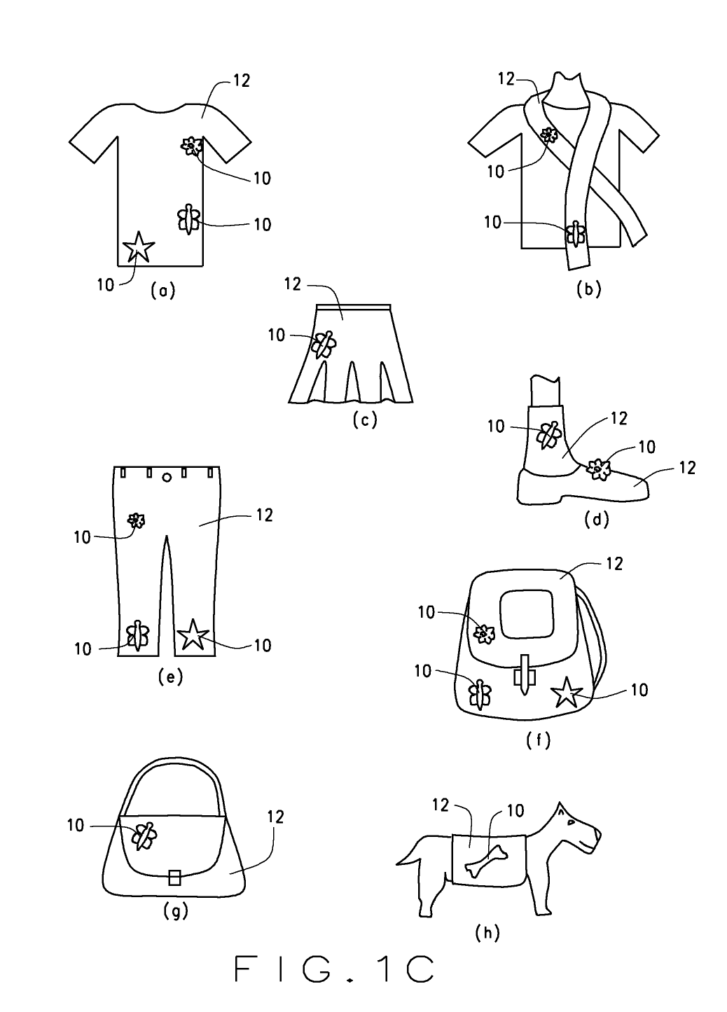

Referring now to FIG. 2, as described above, the first connector 18 can be affixed to or integrally formed with the accessorizing article 14. For example, in various embodiments, the first connector 18 can be substantially permanently affixed to a back side of the accessorizing article 14. In such embodiments, the first connector 18 can be substantially permanently affixed to the back side of the accessorizing article 14 utilizing any suitable fastening means such as glue, adhesive, tape, rivets, welding, soldering, sewing, etc. For example, in various implementations, the first connector 18 can be substantially permanently affixed to the back side of the accessorizing article 14 utilizing a quick setting adhesive that is water resistant, thermally resistant and flexible such that water, varying temperatures and flexing of the accessorizing article 14 will not impair the bonding properties of the adhesive. Or, in other implementations, the first connector 18 can be substantially permanently affixed to the back side of the accessorizing article 14 utilizing a double-stick tape having suitable bonding properties such that water, varying temperatures and flexing of the accessorizing article 14 will not impair the adhesiveness of the tape.

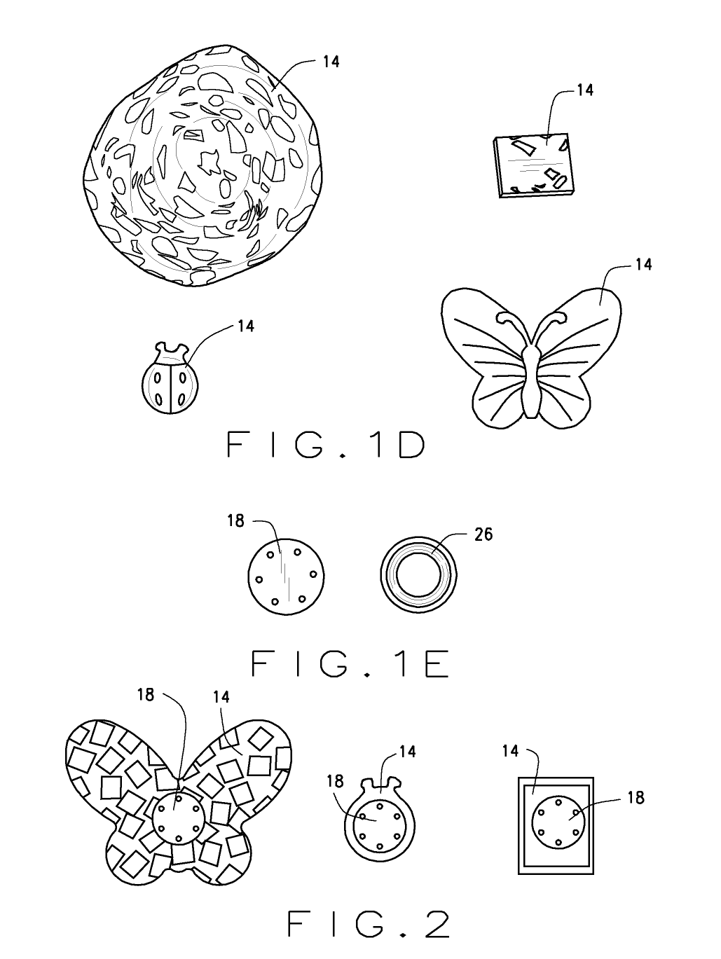

Referring now to FIG. 3, in various embodiments, the first connector 18 can be disposed within an enclosure 30 that is affixed to the back side accessorizing article 14. The enclosure 30 can be any enclosure suitable to retain the first connector 18, be substantially permanently affixed to the back side of the accessorizing article 14, and cause little or substantially no interference with the magnetic field generated by the second connector 26 such that the accessorizing article 14 can be easily attached to any desired location of the personal item 12, as described above. For example, in various embodiments, the enclosure 30 can comprise a cloth or fabric envelope in which the first connector 18 is disposed. Additionally, in such embodiments, the cloth or fabric envelope is substantially permanently affixed to the accessorizing article 14. In other embodiments, the enclosure 30 can comprise a plastic housing in which the first connector 18 is disposed and which is substantially permanently affixed to the accessorizing article 14.

The first connector enclosure 30, having the first connector 18 disposed therein, can be affixed to the accessorizing article 14 utilizing any suitable fastening means such as glue, adhesive, tape, rivets, welding, soldering, sewing, etc. For example, in various implementations, the enclosure 30 can be substantially permanently affixed to the accessorizing article 14 utilizing a quick setting adhesive that is water resistant, thermally resistant and flexible such that water, varying temperatures and flexing of the accessorizing article 14 will not impair the bonding properties of the adhesive. Or, in other implementations, the enclosure 30 can be substantially permanently affixed to the accessorizing article 14 utilizing a double-stick tape having suitable bonding properties such that water, varying temperatures and flexing of the accessorizing article 14 will not impair the adhesiveness of the tape.

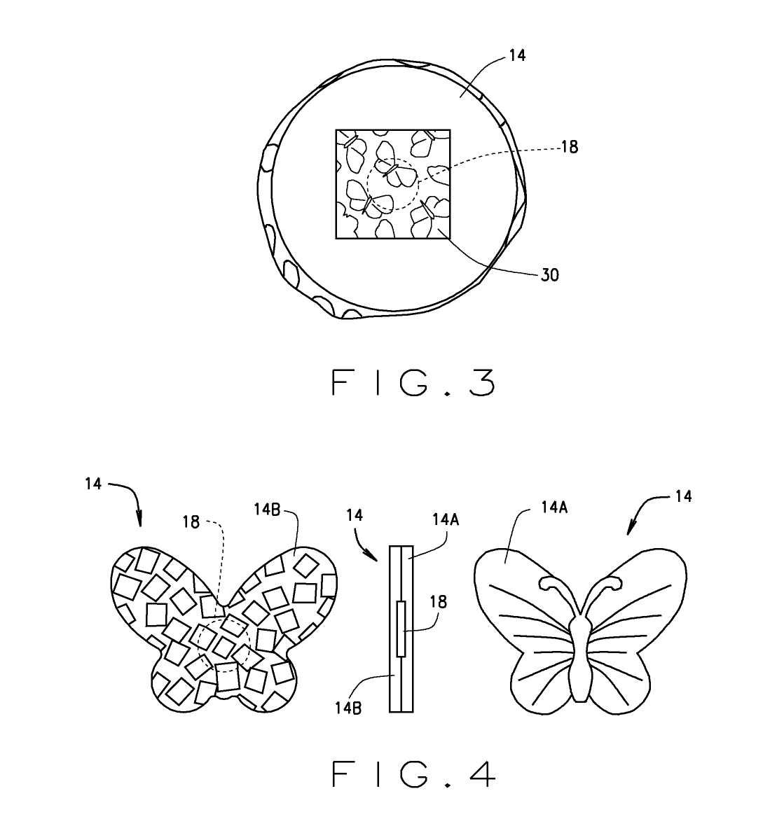

Referring now to FIG. 4, in various embodiments, the first connector can be integrally formed with the accessorizing article 14. That is, the first connector 18 can be embedded in the accessorizing article 14, molded in the accessorizing article 14, encapsulated in the accessorizing article 14, or otherwise integrally formed with the accessorizing article 14. For example, in various implementations, the first connector 18 can be encapsulated between a front face 14A and a back panel 14B of the accessorizing article 14, wherein the front face 14A and the back panel 14B are substantially permanently affixed to each other. For example, in various embodiments, the back panel 14B can be glued, riveted, welded, soldered, sewn, etc., to the front face 14A such that the first connector 18 is encapsulated therebetween. Importantly, the back panel 14B is fabricated of a material that will cause little or substantially no interference with the magnetic field generated by the second connector 26 such that the accessorizing article 14 can be easily attached to any desired location of the personal item 12, as described above.

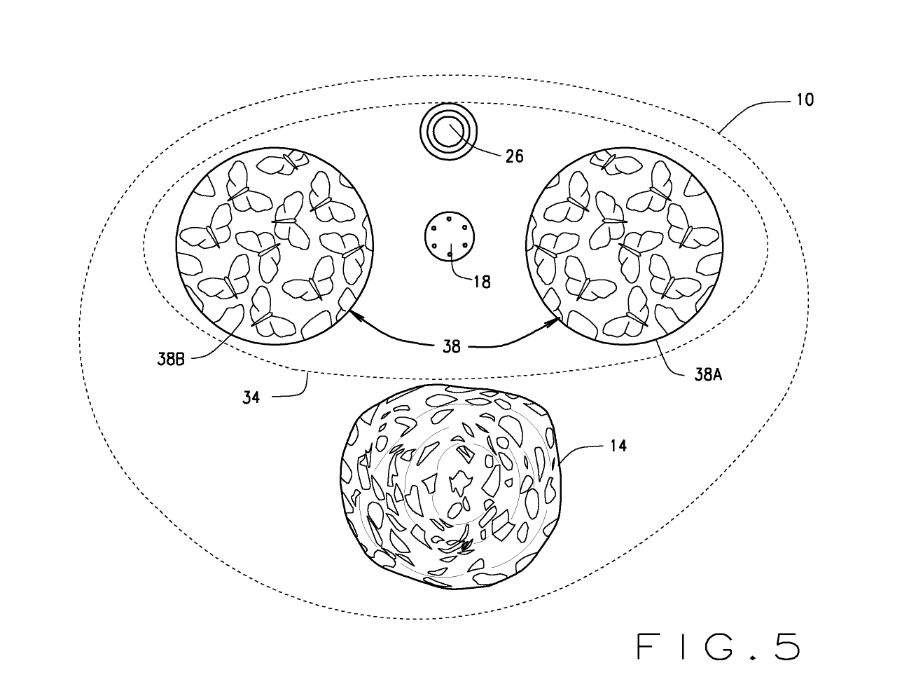

Referring now to FIGS. 5, 5A and 5B, in various embodiments, the MAO item 10 can include a first connector retrofit kit 34, whereby a person can convert any desired accessorizing article 14, i.e., any desired trinket, emblem, piece of jewelry or any other desired item, into a MAO item 10. In such embodiments, the accessorizing article retrofit kit 34 includes the first connector 18, the second connector 26, and a first connector enclosure assembly 38 that is structured and operable to retain the first connector 18 on the back side of the desired accessorizing article 14. More specifically, the first connector enclosure assembly 38 includes a first panel 38A and a second panel 38B, wherein the first and second panels 38A and 38B are connectable such that the first connector 18 can be disposed and retained therebetween. Additionally, one or both of the first and second panels 38A and 38B are attachable to the selected accessorizing article 14.

Accordingly, to convert the selected accessorizing article 14 into the MAO item 10, the first and second panels 38A and 38B are connected, coupled or attached together in such a manner as to construct a pouch (as shown in FIG. 5A) leaving a portion of the constructed pouch, i.e., the semi-assembled first connector enclosure assembly 38, open. Subsequently, the first connector 18 is placed inside the semi-assembled first connector enclosure assembly 38 and the open portion is closed or sealed such that the first connector 18 is retained therein, thereby providing the fully assembled first connector enclosure assembly 38. Next, the assembled first connector enclosure assembly 38 is substantially permanently affixed to the back of the accessorizing item 14, as illustrated in FIG. 5B, thereby substantially permanently affixing the first connector 18 to the back side of the accessorizing article 14.

Importantly, one or both of the front and back panels 38A and 38B is/are fabricated of a material that will cause little or substantially no interference with the magnetic field generated by the second connector 26 such that, once the assembled first connector enclosure assembly 38 is substantially permanently affixed to the back side of the accessorizing article 14, the accessorizing article 14 can be easily attached to any desired location of the personal item 12, as described above.

The front and back panels 38A and 38B can be connected, coupled or attached together using any suitable connecting, coupling or attaching means. For example, front and back panels 38A and 38B can be glued, riveted, welded, soldered, sewn, etc., together. Additionally, the assembled first connector enclosure assembly 38 can be connected, coupled or attached to the selected accessorizing article 14 using any suitable connecting, coupling or attaching means. For example, assembled first connector enclosure assembly 38 can be glued, riveted, welded, soldered, sewn, etc., to the back side of the selected accessorizing article 14.

For example, in various embodiments, the first and second panels 38A and 38B comprise ‘iron-on patch’ fabric, comprising a piece of fabric having a heat activated glue disposed on one side. Hence, in such embodiments, to assemble the first connector enclosure assembly 38, the heat activated glue side of one of the first or second panels 38A or 38B is placed in contact with the fabric side, i.e., the non-heat activated glue side, of the respective first or second panel 38A or 38B. Therefore, the heat activated glue side of one of the first or second panels 38A or 38B is disposed on an exterior of the resulting assembled first connector enclosure assembly 38, assembled as described below. Next, using an iron, or other suitable heating element or device, a portion of the edge of the first or second panel 38A or 38B is heated to adhere to the respective edge portion of the respective first or second panel 38A or 38B, thereby forming the pouch, described above. Next, the first connector 18 is disposed within the pouch and the remaining portion of the edges of the first or second panel 38A or 38B are adhered together, thereby providing the assembled first connector enclosure assembly 38. In various implementations, the first and second panels 38A and 39B can have any predefined shape or size. That is the first and second panels 38A and 39B can be precut to any shape, e.g., a circle, square, triangle, rectangle, heart, diamond, hexagon, oval, etc. Alternatively, after the first connector enclosure assembly 38 has been assembled, as described above, the assembled first connector enclosure assembly 38 can be cut, by person wishing to convert the selected accessorizing article into a MAO item 10, to any shape suitable for attachment to the selected accessorizing article 14, e.g., a circle, square, triangle, rectangle, heart, diamond, hexagon, oval, etc.

Subsequently, in such exemplary embodiments, to attach the assembled first connector assembly 38 to the selected accessorizing article 14, the exteriorly exposed heat activated glue side of the respective first or second panel 38A or 38B is placed in contact with the back side of the selected accessorizing article 14. Then, using an iron, or other suitable heating element or device, the exteriorly exposed heat activated glue side of the respective first or second panel 38A or 38B is heated to adhere to the assembled first connector assembly 38 to the back side of the selected accessorizing article 14, thereby substantially permanently affixing the first connector 18 to the back side of the selected accessorizing article 14. Subsequently, the selected accessorizing article 14 can be easily attached to any desired location of the personal item 12 utilizing the magnetic second connector 26, as described above.

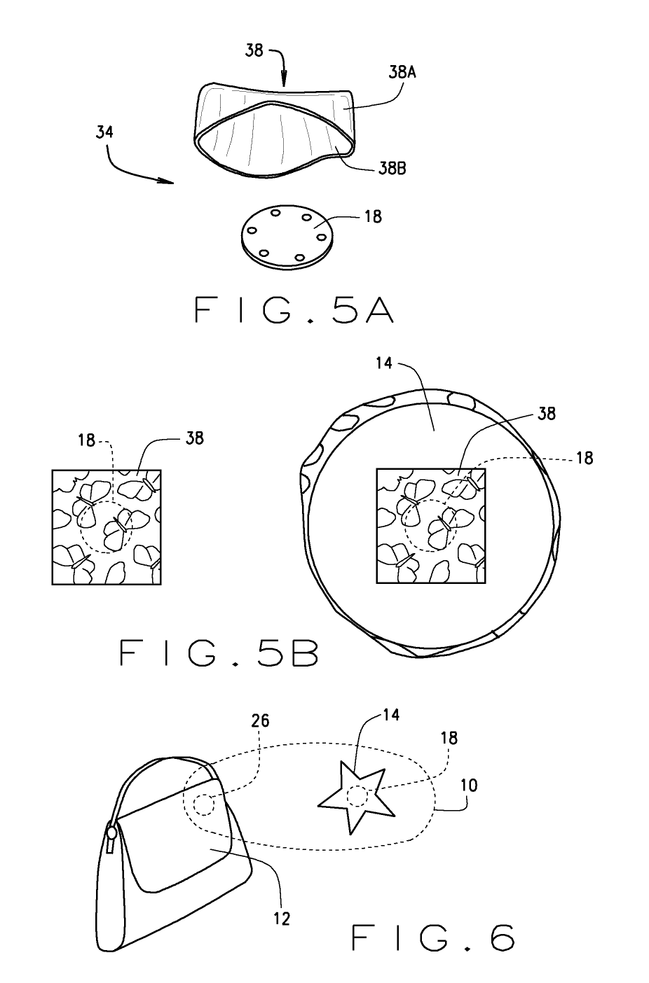

Referring now to FIG. 6, in various embodiments, the personal item 12 can be manufactured or fabricated having the second connector 26 integrally formed with or substantially permanently affixed at a particular location of the personal item 12, such that the accessorizing article 14, having the first connector 18 affixed to or integrally formed therewith, as described above, can be easily attached to the particular location of the personal item 12. For example, a personal item 12, such a purse, handbag or backpack, can be manufactured or fabricated to have one or more second connectors 26 disposed and affixed at one or more particular locations between an interior lining and an exterior layer of the respective personal item 12. Or, the respective personal item 12 can have one or more second connectors 26 substantially permanently affixed, via glue, sewing, riveting, snapping or otherwise, at one or more particular locations to an interior surface or an exterior surface of the respective personal item 12. Accordingly, the accessorizing article 14 can be magnetically attached to the respective personal item 12 at the one or more particular locations via the magnetic attraction between the first and second connectors 18 and 26.

It should be understood that the MAO item 10, as described herein, is also suitable for use with various pet apparel and accessories, e.g., leashes and collars.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A magnetically attachable ornamental item, said ornamental item comprising:
an accessorizing article; and
a magnetic fastener assembly including:
a first connector that forms a part of the accessorizing article; and
a second connector magnetically connectable to the first connector having a portion of a personal item disposed therebetween such that the accessorizing article can be magnetically attached to any desired location of the personal item.

2. The ornamental item of claim 1, wherein the first connector comprises a magnet and the second connector comprises a ferromagnetic material magnetically attracted to the first connector such that the accessorizing article can be attached to any desired location of the personal item.

3. The ornamental item of claim 1, wherein the second connector comprises a magnet and the first connector comprises a ferromagnetic material magnetically attracted to the second connector such that the accessorizing article can be attached to any desired location of the personal item.

4. The ornamental item of claim 1, wherein the first comprises a first magnet and the second connector comprises a second magnet magnetically attracted to the first magnet such that the accessorizing article can be attached to any desired location of the personal item.

5. The ornamental item of claim 1, wherein the first connector is affixed to a back side of the accessorizing article.

6. The ornamental item of claim 1, wherein the first connector is disposed within an enclosure affixable to a back side of the accessorizing article.

7. The ornamental item of claim 1, wherein the first connector is encapsulated between a front face and a back panel of the accessorizing article such that the first connector is integrally formed with the accessorizing article.

8. The ornamental item of claim 1, wherein the second connector forms a part of the personal item.

9. The ornamental item of claim 8, wherein the second connector is disposed between an interior lining and an exterior layer of the personal item, such that the second connector is integrally formed with the personal item.

10. The ornamental item of claim 8, wherein the second connector is substantially permanently affixed to an interior portion of the personal item.

11. A magnetically attachable ornamental item, said ornamental item comprising:
an accessorizing article; and
a magnetic fastener assembly including:
a first connector that forms a part of the accessorizing article; and
a second connector that forms a part of the personal item and is magnetically connectable to the first connector such that the accessorizing article can be magnetically attached to the personal item.

12. The ornamental item of claim 11, wherein the first connector comprises a magnet and the second connector comprises a ferromagnetic material magnetically attracted to the first connector such that the accessorizing article can be attached to any desired location of the personal item.

13. The ornamental item of claim 11, wherein the second connector comprises a magnet and the first connector comprises a ferromagnetic material magnetically attracted to the second connector such that the accessorizing article can be attached to any desired location of the personal item.

14. The ornamental item of claim 11, wherein the first comprises a first magnet and the second connector comprises a second magnet magnetically attracted to the first magnet such that the accessorizing article can be attached to any desired location of the personal item.

15. ornamental item of claim 11, wherein the first connector is affixed to a back side of the accessorizing article.

16. The ornamental item of claim 11, wherein the first connector is disposed within an enclosure affixed to a back side of the accessorizing article.

17. ornamental item of claim 11, wherein the first connector is encapsulated between a front face and a back panel of the accessorizing article such that the first connector is integrally formed with the accessorizing article.

18. The ornamental item of claim 11, wherein the second connector is disposed between an interior lining and an exterior layer of the personal item, such that the second connector is integrally formed with the personal item.

19. The ornamental item of claim 18, wherein the second connector is substantially permanently affixed to one of an interior surface and an exterior surface of the personal item.

20. A system for magnetically attaching an ornamental item to a personal item, said system comprising:
a first connector;
a first connector enclosure assembly structured and operable to enclose and retain the first connector and attach to an accessorizing article, the first connector enclosure assembly comprising:
a first panel; and
a second panel connectable to the first panel to encapsulate the first connector therebetween; and
a second connector magnetically connectable to the first connector having a portion of a personal item disposed therebetween such that the accessorizing article can be magnetically attached to any desired location of the personal item.
